(19) United States
(12) Patent Application Publication
(10) Pub. No.: US 2008/0121350 A1
(43) Pub. Date: May 29, 2008

(54) Window covering with spring-assisted roll-up devices at upper and lower rails

(76) Inventor: Li-Ming Cheng, Kaohsiung City (TW)

Correspondence Address: BIRCH STEWART KOLASCH & BIRCH, PO BOX 747, FALLS CHURCH, VA, 22040-0747, US

(21) Appl. No.: 11/522,991

(22) Filed: Sep. 19, 2006

(51) Int. Cl. E06B 9/322

(52) U.S. Cl. 160/170

(57) ABSTRACT

A window covering with spring-assisted roll-up devices at upper and lower rails at least includes an upper rail, blind cord sets, a blinds set, a lower rail and spring-assisted roll-up devices, wherein the spring-assisted roll-up devices are respectively installed inside the upper and lower rails and the rolling wheel sets are installed at the two ends of each the upper and lower rails, and the ends of the blind cord sets are respectively fixed at the upper rail and at the lower rail which are adjacent to the blinds set and the blind cord sets may connect the blinds set. Thereby, through the spring-assisted roll-up devices dispersing the rolling strength, the user can synchronously control the roll-up and pulling of the cordless window covering for providing the user a better convenience.

### FIELD OF THE INVENTION

The present invention is related to window coverings with spring-assisted roll-up devices at upper and lower rails, and more particularly to cordless window coverings whose spring-assisted roll-up devices are mounted on the upper and lower rails thereof for providing the user the convenience of roll-up and pulling down.

### BACKGROUND OF THE INVENTION

There are various kinds of window coverings in the market, for example Venetian blinds, Pleated shade, Roma blind etc. They are installed at windows for sun protection and decoration. According to different demands of users, generally, the window covering structure can be divided into two kinds: one is a window covering structure using a cord to control rolling up and pulling down and the other is a cord-free window covering 10 as shown in FIGS. 1 and 2. The cordless window covering 10 includes an upper rail 11, a blinds set 12, which can be folded and pulled, mounted under the upper rail 11, a lower rail 13 mounted under the blinds set 12, and a control module 14 installed inside the upper rail 11, connected to the blinds set 12 for controlling the roll-up and pulling down thereof and cooperating a rolling spring (not shown) with a cord set 15 (which can be directly formed as two cords or one collected cord), one end of which 151 is fixed at the lower rail 13, for winding around a rolling wheel set 141.

Further, please refer to FIG. 3. The control module 14 also can be installed inside the lower rail 13 for connecting to the blinds set 12 and controlling the folding and pulling thereof, and cooperating a rolling spring (not shown) with a cord set 15 (which can be directly formed as two cords or one collected cord), one end 151 is fixed at the upper rail 11, for winding around the rolling wheel set 141.

When the user wants to roll up the cordless window covering 10, he or she can directly hold the lower rail 13 at the bottom of the blind set 12 and force upwardly, and then through the spring-assisted roll-up function of the control module 14, the roll-up of the blind set 12 can be completed. Further, when the user wants to pull down the cordless window covering 10, identically, he or she can hold the lower rail 13 at the bottom of the blind set 12 and force downwardly, and then through the operation of the control module 14, the downward pulling can be completed. Thereby, a window covering structure which folding and pulling can be controlled without a cord is provided.

Moreover, the cordless window covering 10 also can be a heavy-type cordless window covering. When used, the user usually has to hold the lower rail 13 first for forcing the blinds set 12 for rolling up or pulling down the blinds set 12. However, if only one spring device is used or the device is not strong enough, the user may not have enough strength or can not force up more, the heavy-type cordless window covering 10 might still fall down beyond expectation (as shown in FIG. 4) owing to an insufficient collecting strength of the control module 14 even though the blinds set 12 has already rolled up by the user to a height. Therefore, to avoid this situation, the control module 14 has to be enhanced (not shown) for rolling up or pulling down the blinds set 12 to a predetermined height without the unexpected falling-down. However, if the spring-assisted device used in the upper rail is too strong, user may not have enough strength to pull the window covering down alone, and user may also feel difficult and has to ask for help for moving the lower rail 13 and pulling the blinds set 12. Therefore, it is inconvenient for the user to control the folding and pulling of the heavy-type window covering, and this situation obviously needs to be improved.

### SUMMARY OF THE INVENTION

The present invention provides a window covering with spring-assisted roll-up devices simultaneously on upper and lower rails. Through this design, the problem that the blind set of the conventional heavy-type cordless window covering can not be maintained at a predetermined height as roll-up or pulling down can be solved, and through the spring-assisted roll-up devices simultaneously installed on the upper and lower rails of the cordless window covering, the roll-up and pull-down of the window covering can be controlled synchronously.

To achieve the purposes above, the present invention provides a window covering with spring-assisted roll-up devices on upper and lower rails which includes an upper rail, blind cord sets, a blinds set, a lower rail and spring-assisted roll-up devices. The spring-assisted roll-up devices are respectively installed inside the upper and the lower rails, and the number of the blind cord sets is two, wherein in one cord set of blind, one end of the blind cord is fixed at the lower rail and the other end is upwardly extended to connect the blind set, winds around the rolling wheel set on the upper rail and gathers at the spring-assisted roll-up device inside the upper rail, and in the other set, one end of the blind cord is fixed at the upper rail and the other end is downwardly extended to connect the blinds set, winds around the rolling wheel set on the lower rail and gathers at the spring-assisted roll-up device inside the lower rail.

As the design described above, the spring-assisted roll-up devices can be installed inside the upper and the lower rails respectively. By which the rolling strength can be dispersed, the spring-assisted roll-up devices on the upper and the lower rails will assist the user who does not has enough strength in controlling the roll-up of the cordless window covering synchronously. The gravity and the weight of the window covering with spring-assisted roll-up devices on lower rails will let user save most strength in controlling the pull-down of the cordless window covering. The present invention effectively solves the problem of insufficient strength and provides a great convenience.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing a conventional cordless window covering with a control module installed at an upper rail thereof;

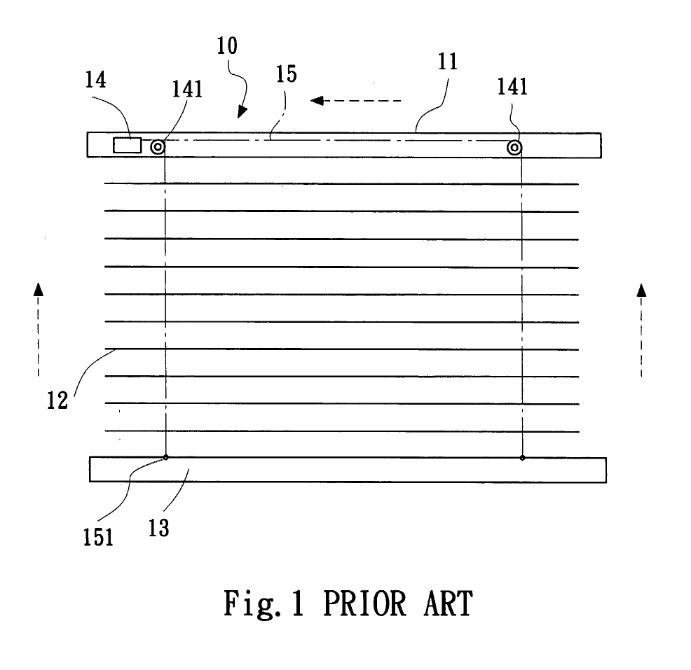

FIG. 2 is a schematic view showing a rolling up of the blinds set in FIG. 1;

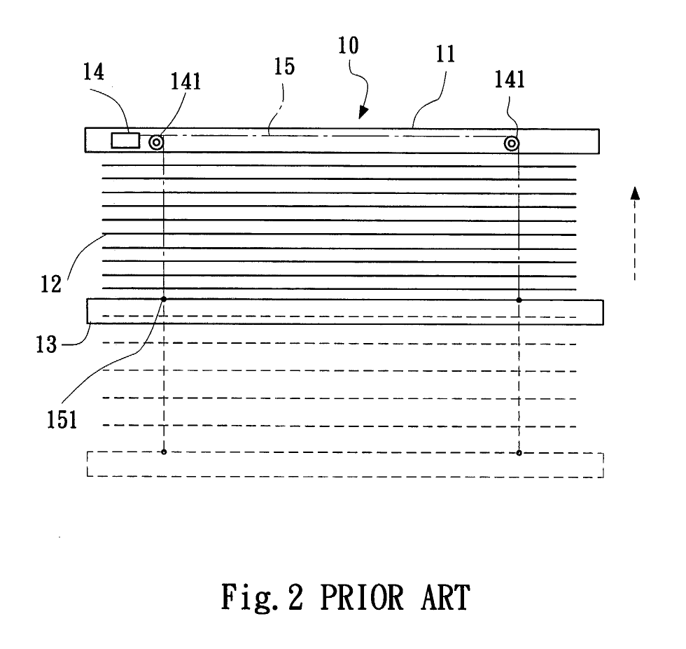

FIG. 3 is a schematic view showing a conventional cordless window covering with a control module installed at a lower rail thereof;

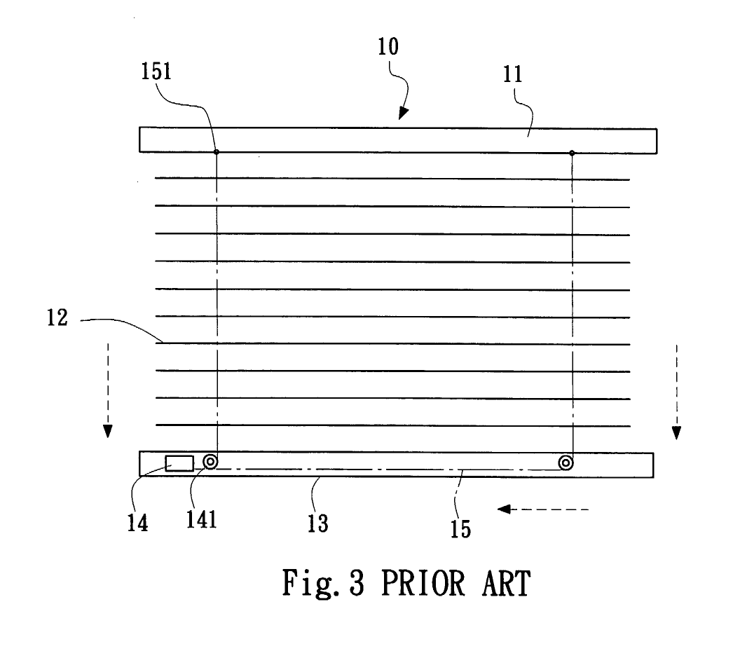

FIG. 4 is a schematic view showing a roll-up and a falling-down of the blinds set in FIG. 3;

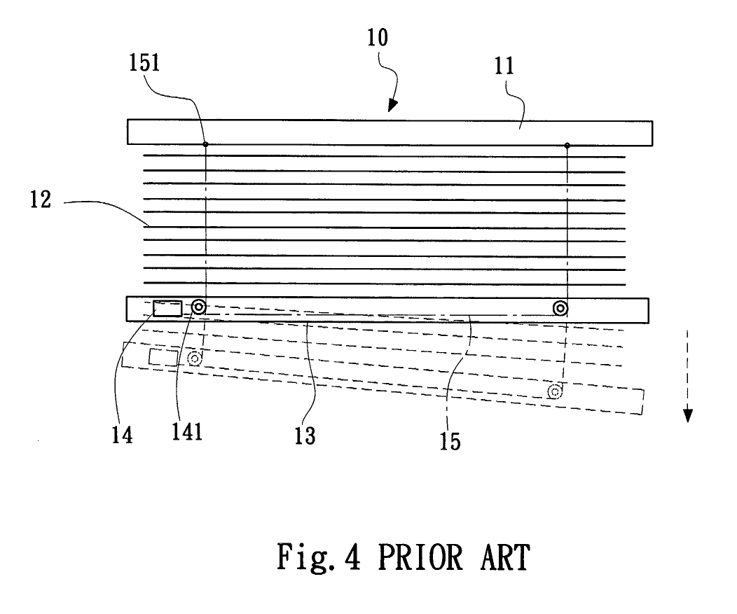

FIG. 5 is a front view showing an assembling of the present invention; and

FIG. 6 is a schematic view showing the control of roll-up and pulling-down of window covering in FIG. 5.

### DETAILED DESCRIPTION OF THE PREDERRED EMBODIMENTS

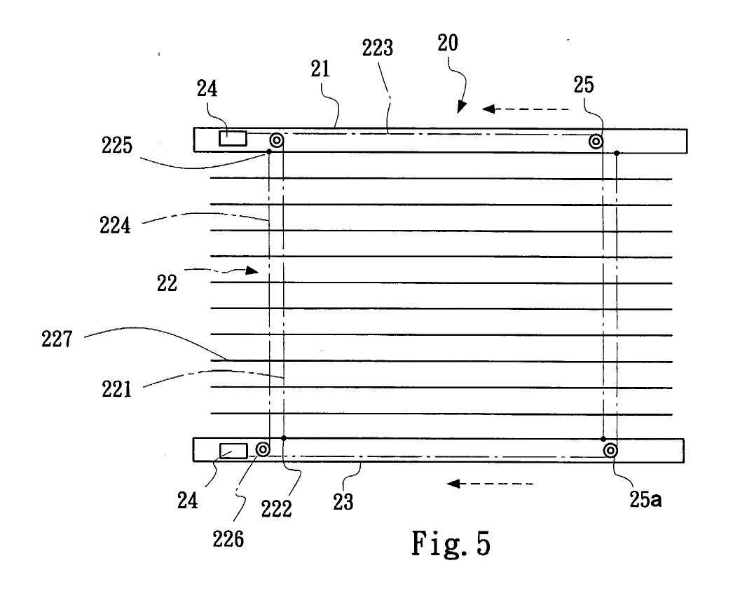

Please refer to FIG. 5. According to the present invention, spring-assisted roll-up devices 24 are installed at an upper rail 21 and a lower rail 23 of a cordless window covering 20 respectively, and the cordless window covering 20, as described above, includes the upper rail 21, blind cord sets 22, a blinds set 227, the lower rail 23 and the spring-assisted roll-up devices 24.

The spring-assisted roll-up devices 24 are respectively installed inside the upper rail 21 and the lower rail 23 of the cordless window covering 20. Each spring-assisted roll-up device 24 has an elastic element (not shown), which can be cooperated with a rolling of rolling wheel sets 25, 25a, which are respectively located at two ends of the inner portions of the upper and lower rails 21, 23, for straining or relaxing the blind cord sets 22, which winds around the rolling wheel sets and connects the blinds set 227, so as to roll up or pull down the blinds set 227.

Further refer to FIG. 5, the number of the blind cord sets 22 can be performed to be two: in one set of blind cord, one end 222 of the blind cord 221 is fixed at the lower rail 23 and the other end 223 is upwardly extended to connect the blinds set 227, winds around the rolling wheel set 25 on the upper rail 21 and gathers at the spring-assisted roll-up device 24 inside the upper rail 21; and in the other set of blind cord, one end 225 of the blind cord 224 is fixed at the upper rail 21 and the other end 226 is downwardly extended to connect the blinds set 227, winds around the rolling wheel set 25a on the lower rail 23 and gathers at the spring-assisted roll-up device 24 inside the lower rail 23. Thereby, the purpose of straining or relaxing the blind cord sets 22 and synchronously controlling the roll-up or pulling-down of the window covering 20 can be achieved so as to provide the user a better convenience.

Further as shown in FIG. 5, rolling wheel sets 25, 25a are installed respectively inside the upper and the lower rails 21, 23. When the rolling wheel sets 25, 25a are respectively connected to the blind cords 221, 224, the rolling wheel sets 25, 25a can be rejected by the blind cords 221, 224 for facilitating the roll-up.

In the embodiment of FIG. 5, the number of respective blind cords 221, 224 of the blind cord sets 22 which are gathered, as described above, at the spring-assisted roll-up devices 24 inside the upper and the lower rails 21, 23 can be performed to be one. However, it also can be more than one.

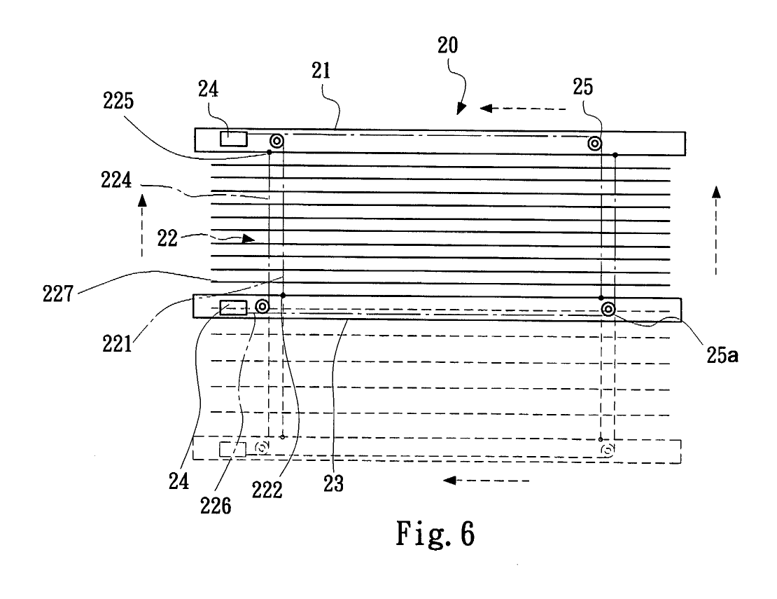

When operating the blinds set 227 of the cordless window covering 20, as shown in FIG. 6, the user may push (or pull) the lower rail 23 by hand, and, through the blind cord sets 22 fixed at the upper and the lower rails 21, 23, the spring-assisted roll-up devices 24 inside the upper and the lower rails 21, 23 can disperse the rolling strength so that the blinds set 227 can synchronously achieve the roll-up or pulling-down operations. Therefore, the user may operate more easily and more conveniently.

In the aforesaid, the window covering with spring-assisted roll-up devices both at the upper and lower rails 21, 23 in the present invention is characterized that the spring-assisted roll-up devices 24 simultaneously installed inside the upper and lower rails 21, 23 for all kinds of cordless window covering 20 can provide the user with the synchronous controlling of rolling up and pulling down the blind set 227 so that when the user does not have enough strength, the spring-assisted roll-up devices 24 inside the upper and the lower rails 21, 23 can disperse the rolling strength for facilitating the control of roll-up and pulling down the cordless window covering 20 and also providing a great convenience.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A window covering with spring-assisted roll-up devices simultaneously located at an upper rail and a lower rail, comprising an upper rail, a blinds set, a lower rail, two spring-assisted roll-up devices, and a blind cord set for each the spring-assisted roll-up device, wherein
the upper rail and the lower rail have an spring-assisted roll-up device respectively, and
an end of each the blind cord sets is respectively fixed at the upper rail and the lower rail for connecting the blinds set.

2. The window covering as claimed in claim 1, wherein rolling wheel sets for being wound by the blind cord sets are further installed inside the upper rail and the lower rail.

3. The window covering as claimed in claim 2, wherein, in one set of the bind cord sets, the end of the blind cord is fixed at the lower rail and other end is upwardly extended to connect the blinds set, winds around the rolling wheel set on the upper rail and gathers at the spring-assisted roll-up device inside the upper rail, and in the other set, the end of the blind cord is fixed at the upper rail and other end is downwardly extended to connect the blinds set, winds around the rolling wheel set on the lower rail and gathers at the spring-assisted roll-up device inside the lower rail.

4. The window covering as claimed in claim 3, wherein each the blind cord set which is gathered at the spring-assisted roll-up device respectively inside the upper rail and the lower rail includes at least one cord.
